(19) United States
(12) Patent Application Publication
(10) Pub. No.: US 2017/0238536 A1
(43) Pub. Date: Aug. 24, 2017

(54) Drift Control Formulations for use with Air Induction Nozzles

(71) Applicant: RHODIA OPERATIONS, Paris (FR)

(72) Inventors: Rajesh GOYAL, Vadodara (IN); Neal RYAN, Bensalem, PA (US); Hong LIU, Pennington, NJ (US); Krish SHANMUGA, Plainsboro, NJ (US); Michael J. KISENWETHER, Dallas, PA (US); Marc BALASTRE, Singapore (SG)

(73) Assignee: RHODIA OPERATIONS, Paris (FR)

(21) Appl. No.: 15/439,124

(22) Filed: Feb. 22, 2017

Related U.S. Application Data
(60) Provisional application No. 62/298,047, filed on Feb. 22, 2016.

(51) Int. Cl. A01N 25/24; A01N 57/12; A01N 39/04; A01N 37/40

(52) U.S. Cl. CPC A01N 25/24; A01N 37/40; A01N 57/12; A01N 39/04

(57) ABSTRACT

A method of spray applying an agricultural pesticide composition through an induction flat spray tip nozzle, wherein the agricultural pesticide composition comprises: a liquid medium; at least one pesticide dissolved or dispersed in the liquid medium; and a guar or a guar derivative, wherein at least a portion of the guar or guar derivative, typically a cationic guar, is in the form of particles and at least a portion of the particles are dispersed in the liquid medium, wherein the induction flat spray tip nozzle comprises: a spray tip nozzle body comprising: a first end capable of being connected to a liquid supply, a venturi compartment; and a discharge orifice.

### CROSS-REFERENCE TO RELATED APPLICATIONS

This application claims the benefit of U.S. Provisional Application Ser. No. 62/298,047, filed Feb. 22, 2016, incorporated herein by reference in its entirety.

### FIELD OF THE INVENTION

This invention relates to sprayable, flowable liquid pesticide compositions having concentrated suspensions of water-soluble polymers and, in particular, to methods of spray applying such pesticide compositions through a nozzle, which can be in certain embodiments an induction flat spray tip nozzle.

### BACKGROUND

Typically, agrochemical treatment of crops is through spray applying (or spraying) agrochemicals as a dilute liquid spray onto the crop. This is accomplished generally through use of hydraulic nozzles. These nozzles generally have a nozzle body or spray tip body which incorporates functional components to enable the atomization and distribution of a liquid spray, as well as providing a means of attachment to a movable spray unit. Depending on the desired application, hydraulic nozzles can produce either a flat fan, hollow cone, or solid cone of droplets.

Water-soluble polymers, particularly polysaccharide polymers, such as, for example, guar, guar derivatives, starches, and cellulosic polymers, are commercially available materials used in a variety of applications, including as ingredients in agricultural pesticide compositions.

### SUMMARY OF THE INVENTION

In many agricultural applications, a polymer in the form of a dry powder is added to an aqueous medium and dissolved to form a viscous aqueous solution. In some applications, it would also be desirable to provide a liquid concentrate that has high polymer content and that could simply be diluted to the desired end-use concentration for agricultural uses. This approach can be difficult, for example, concentrated aqueous polysaccharide polymer solutions tend to be highly viscous and difficult to handle. Often times, ammonium containing compounds such as ammonium sulphate (AMS), diammonium phosphate (DAP), and urea ammonium nitrate (UAN) can be used to control polysaccharide hydration.

In the agricultural industry, ammonium containing compounds such as ammonium sulphate (AMS), diammonium phosphate (DAP), and urea ammonium nitrate (UAN), among others, are conventionally used to control polysaccharide hydration as well as in water conditioning. Use of AMS, DAP and UAN, among others, have been widely adopted in agricultural practices, especially in “hard water” areas. In these areas, tank mixes containing, as a large component thereof, “hard water” along with pesticides, including herbicides (e.g., glyphosate) and the like, as well as other components.

To combat the rise of glyphosate-resistant weeds, the trend in the agricultural industry has shifted away from utilizing only glyphosate to other herbicides or a combination of glyphosate with other herbicides. Other herbicides, for example, dicamba and its salts, can be utilized. However, dicamba and its salts are generally incompatible with ammonium containing compounds used for water conditioning. As such, it is desirable to replace these ammonium containing compounds with alternative compounds that are compatible with dicamba and its salts. In one embodiment, the compositions as described herein are free of added ammonium containing compounds or are prepared in the absence of ammonium containing compounds. In another embodiment, the composition as described herein are substantially free of ammonium containing compounds, meaning no ammonium containing compounds have been added to the composition.

There is also a continuing interest in providing polymers in a convenient form that exhibits good handling properties and good storage stability.

In one aspect, the air induction nozzle for use with the present invention is in one embodiment constructed with a venturi compartment (with an embedded venturi induction port) fabricated into the nozzle assembly.

The venturi compartment typically comprises a longitudinally extending throughhole with an inlet opening in fluid communication with an outlet opening and a venturi section interposed and in fluid communication with said inlet opening and said outlet opening. In one embodiment, the venturi section tapers in a constricting manner from inlet opening to constrict the flow of fluid therethrough, to cause the velocity of the fluid to increase and the pressure of the fluid to decrease. The venturi section terminates at a venturi throat. The throughhole also comprises an expansion section which is disposed downstream from venturi section, and between the venturi section and outlet opening. The expansion section allows the fluid which flows through venturi section to expand on the downstream side of venturi throat. The venturi compartment includes at least one venturi induction port that is in fluid communication with the throughhole. In this manner, as a first fluid (e.g., a pesticide formulation) flows through the venturi compartment throughhole, a vacuum is created in connection with the venturi induction port that draws in a second fluid (e.g., air) for combining with the first fluid to form a fluid mixture prior to exiting the nozzle.

The venturi induction port creates a vacuum that induces the flow of ambient air into the nozzle, resulting in enlarged droplet size spectra in an attempt to mitigate spray drift, that is, the unintended and undesirable movement of spray droplets away from their intended target. More specifically, such venturi nozzles are designed to draw air into the nozzle body, in order to incorporate air, or more specifically, an air bubble into the middle of the droplet. The resultant droplets typically fall into the very coarse, extremely coarse and ultra-coarse droplet category. The combination of larger spray droplets and fewer driftable fine spray particles make the venturi nozzles desirable for use with dicamba pesticides, along with other pesticides in combination with dicamba, as compared to spraying than conventional flat fan nozzles. Furthermore, because the droplet incorporates air, such droplet falls to the targeted crop or area at a slightly slower speed than a solid droplet would. When these larger droplets hit the desired crops, they have a greater probability to stick to leaf tissue, further reducing the potential for spray drift. Ambient wind, coupled with small sized droplets, is the prime cause of spray drift. Droplet size can be affected by the orifice size of the nozzle spray tip and/or by the degree of air entrainment. Air induction nozzles, however, face similar issues as other types of nozzles, e.g., undesirable fines produced.

In many agricultural spray applications, a polymer in the form of a dry powder is added to an aqueous medium and dissolved to form a viscous aqueous or semi-aqueous solution. In some applications, it would also be desirable to provide a liquid concentrate that has high polymer content and that could simply be diluted to the desired end-use concentration for agricultural uses. This approach can be difficult, for example, concentrated aqueous polysaccharide polymer solutions tend to be highly viscous and difficult to handle. Often times, ammonium containing compounds such as ammonium sulphate (AMS), diammonium phosphate (DAP), and urea ammonium nitrate (UAN) can be used to control polysaccharide hydration.

In the agricultural industry, ammonium containing compounds such as ammonium sulphate (AMS), diammonium phosphate (DAP), and urea ammonium nitrate (UAN), among others, are conventionally used to control polysaccharide hydration as well as water conditioning. Use of AMS, DAP and UAN, among others, have been widely adopted in agricultural practices, especially in “hard water” areas. In these areas, tank mixes containing, as a large component thereof, “hard water” along with pesticides, including herbicides (e.g., glyphosate) and the like, as well as other components.

To combat the rise of glyphosate-resistant weeds, the trend in the agricultural industry has shifted away from utilizing only glyphosate to other herbicides or a combination of glyphosate with other herbicides. Other herbicides, for example, dicamba and its salts, can be utilized. However, dicamba and its salts are generally incompatible with ammonium containing compounds used for water conditioning. As such, dicamba is not recommended to be used with ammonium containing compounds. It is desirable to replace these ammonium containing compounds with alternative compounds that are compatible with dicamba and its salts. In one embodiment, the compositions as described herein are free of added ammonium containing compounds or are prepared in the absence of ammonium containing compounds. In another embodiment, the composition as described herein are substantially free of ammonium containing compounds, meaning no ammonium containing compounds have been added to the composition. In another embodiment, the term “substantially free of ammonium containing compounds” means having less than 1 wt % (by weight of composition) of ammonium-containing compounds. In another embodiment, the term “substantially free of ammonium containing compounds” means having less than 0.5 wt % (by weight of composition) of ammonium-containing compounds. In yet another embodiment, the term “substantially free of ammonium containing compounds” means having less than 2 wt % (by weight of composition) of ammonium-containing compounds.

There is also a continuing interest in providing polymers in a convenient form that exhibit good handling properties and good storage stability.

More specifically, there is a continuing interest in providing pesticide composition containing polymers for use with specific types of spray nozzles in the agricultural industry that exhibit good spray and drift control properties, including the ability to flow or be pumped, and good storage stability.

In a first aspect, described herein are methods of spray applying an agricultural pesticide composition through an induction flat spray tip nozzle, wherein the agricultural pesticide composition comprises:
a liquid medium;
at least one pesticide dissolved or dispersed in the liquid medium; and
a guar or a guar derivative,

wherein the induction flat spray tip nozzle comprises a spray tip nozzle body which comprises: a first end adapted to connect to a liquid supply, a venturi compartment; and a discharge orifice.

In some embodiments, at least a portion of the guar or guar derivative is in the form of particles and at least a portion of the particles are dispersed in the liquid medium.

In another aspect, described herein are concentrated agricultural adjuvant compositions, comprising, based on 100 parts by weight of the composition:
greater than 1 parts by weight (otherwise referred to herein as “pbw”) of an incompletely hydrated water-soluble polymer suspended in a liquid medium;
a hydration inhibitor component; and
a suspending agent in an amount effective to impart shear thinning properties to the composition.

The agricultural adjuvant composition is free or substantially free of ammonium containing compounds. The water-soluble polymer is, in some embodiments, a water-soluble polysaccharide polymer. In one embodiment, the hydration inhibitor component comprises a glycerine-based solvent or co-solvent, including but not limited to glycerine or glycerine derivatives. In one embodiment, the hydration inhibitor component is polyethylene glycol.

In yet another embodiment, the concentrated agricultural adjuvant composition can comprise at least one additional component. For example, the additional component comprises at least one of: choline chloride, an anti-foam agent, an anionic or nonionic surfactant, a preservative, or a biocide. In another embodiment, the concentrated agricultural adjuvant composition further comprises a choline salt, choline chloride, choline bicarbonate, choline dihydrogen citrate, choline bitarate, potassium hydrogen phosphate, potassium carbonate, dibasic potassium phosphate, or any combination thereof.

In another aspect, described herein are pesticide formulations for use in spray applications. In one embodiment, the pesticide formulations comprise at least one pesticide and the concentrated adjuvant compositions as described herein. The pesticide formulation can further comprise a liquid medium, typically an aqueous medium. The pesticide composition or concentrated adjuvant composition in one embodiment is free of added ammonium containing compounds.

In one embodiment, the concentrated adjuvant composition can additionally comprise one or more surfactants, glycerine, one or more water conditioning agents, one or more preservatives, one or more anti-foam agents, or any mixture thereof. In one embodiment, the suspending agent is selected from fumed silica, inorganic colloidal or colloid-forming particles, rheology modifier polymers, such as xanthan gum (herein alternatively referred to as “xanthan”), or mixtures thereof.

The hydration inhibitor component is typically present in an amount effective to inhibit hydration of the water-soluble polysaccharide in the desired amount in the aqueous medium.

In another embodiment, the hydration inhibitor component can further comprise at least one of: one or more surfactant compounds, one or more water-soluble non-surfactant salts, or one or more water dispersible organic solvents.

In another embodiment, the concentrated adjuvant composition can further comprise one or more pesticide active ingredients, wherein the water-soluble polymer enhances delivery of the pesticide active ingredient from the liquid medium to a target substrate.

The liquid medium can be an aqueous liquid medium, in one embodiment. The liquid medium can be a semi-aqueous liquid medium, in another embodiment. In another embodiment, the liquid medium is water. In another embodiment, the liquid medium is water and a water miscible organic liquid.

In yet another embodiment, the liquid medium is an aqueous liquid medium that comprises water and a water immiscible organic liquid. The resulting composition can be in the form of an emulsion, a microemulsion, or a suspoemulsion.

In one embodiment, the water-soluble polymer is selected from polyacrylamide polymers, non-derivatized guar polymers, derivatized guar polymers, and mixtures thereof, and -the suspending agent is selected from fumed silicas, inorganic colloidal or colloid-forming particles, rheology modifier polymers, water-soluble polysaccharide polymers other than the non-derivatized or derivatized guar, and mixtures thereof. In one embodiment, the suspending agent is not or cannot be non-derivatized or derivatized guar. In one embodiment, the suspending agent is xanthan.

In one embodiment, the concentrated adjuvant composition exhibits a viscosity of less than 10 Pa·s at a shear rate of greater than or equal to 10 s⁻¹.

In another aspect, described herein are concentrated adjuvant compositions, comprising, based on 100 parts by weight of the composition,
from about 2 to about 20 parts by weight of a guar polymer suspended in aqueous medium, said guar polymer having a weight average molecular weight of from about 100,000 to about 5,000,000 grams per mole
   a hydration inhibitor component; and
   a suspending agent, which is different than the guar polymer, in an amount effective to impart shear thinning properties to the composition;
   wherein said composition exhibits:
      (a) a viscosity of greater than or equal to 5 Pa·s at a shear rate of less than 0.01 s⁻¹, and
      (b) a viscosity of less than 5 Pa·s at a shear rate of greater than 10 s⁻¹

In another aspect, described herein are methods of applying an agricultural pesticide composition the steps of:
contacting at least one pesticide with an adjuvant composition,
   wherein the adjuvant composition comprises:
   greater than 1.8 wt %, based upon total weight of the adjuvant composition, of an incompletely hydrated water-soluble polymer suspended in a liquid medium;
   a hydration inhibitor component comprising a glycol, a glycol derivative, choline chloride, dibasic potassium phosphate or a combination thereof; and
   a suspending agent in an amount effective to impart shear thinning properties to the composition;
spray applying a resulting mixture of the at least one pesticide and the adjuvant composition to one or more crops through an induction flat spray tip nozzle,
wherein the induction flat spray tip nozzle comprises a spray tip nozzle body which comprises:
   a first end adapted to connect to a liquid supply,
   a venturi compartment; and
   a discharge orifice,
wherein the agricultural pesticide composition is free or substantially free of ammonium-containing compounds.

In another embodiment, the (i) water-soluble polymer or (ii) guar or derivatized guar comprises, by weight of composition: greater than 2 wt % of the concentrated adjuvant composition. In another embodiment, the (i) water-soluble polymer or (ii) the guar or derivatized guar comprises, by weight of adjuvant composition, greater than 1.8 wt %. In yet another embodiment, the (i) water-soluble polymer or (ii) the guar or derivatized guar comprises, by weight of adjuvant composition, greater than 2.1 wt %, 2.2 wt %, or 2.3 wt %. In another embodiment, the (i) water-soluble polymer or (ii) the guar or derivatized guar comprises, by weight of composition, greater than 2.4 wt %. In another embodiment, the (i) water-soluble polymer or (ii) the guar or derivatized guar comprises, by weight of composition, greater than 2.5 wt %. In another embodiment, the (i) water-soluble polymer or (ii) the guar or derivatized guar comprises, by weight of composition, greater than 2.5 wt %, 2.6 wt %, 2.7 wt %, 2.8 wt %, 3 wt %, 4 wt %, 5 wt %, 6 wt %, 7 wt %, 8 wt %, 9 wt % or 10 wt %.

In another embodiment, the (i) water-soluble polymer or (ii) the guar or derivatized guar comprises, by weight of end use formulation or pesticide composition, greater than 0.01 wt %. In another embodiment, the (i) water-soluble polymer or (ii) the guar or derivatized guar comprises, by weight of end use formulation or pesticide composition, greater than 0.02 wt %. In yet another embodiment, the (i) water-soluble polymer or (ii) the guar or derivatized guar comprises, by weight of end use formulation or pesticide composition, greater than 0.02 wt %, 0.03 wt %, or 0.04 wt %. In another embodiment, the (i) water-soluble polymer or (ii) the guar or derivatized guar is present in the end use formulation or pesticide composition at an upper limit of 0.1 wt % (by weight of end use formulation or pesticide composition), inclusively. In another embodiment, the (i) water-soluble polymer or (ii) the guar or derivatized guar is present in the end use formulation or pesticide composition at an upper limit of 0.08 wt % (by weight of end use formulation or pesticide composition), inclusively. In another embodiment, the (i) water-soluble polymer or (ii) the guar or derivatized guar is present in the end use formulation or pesticide composition at an upper limit of 0.6 wt % (by weight of end use formulation or pesticide composition), inclusively.

### DETAILED DESCRIPTION OF INVENTION AND PREFERRED EMBODIMENTS

As used herein, “liquid medium” means a medium that is in the liquid phase at a temperature of 25° C. and a pressure of one atmosphere. The liquid medium may be a non-aqueous liquid medium or an aqueous liquid medium.

In one embodiment, the liquid medium is an aqueous liquid medium. As used herein, the terminology “aqueous medium” means a single phase liquid medium that contains more than a trace amount of water, typically, based on 100 pbw of the aqueous medium, more than 0.1 pbw water. Suitable aqueous media more typically comprise, based on 100 pbw of the aqueous medium, greater than about 5 pbw water, even more typically greater than 10 pbw water. In one embodiment, the aqueous emulsion comprises, based on 100 pbw of the aqueous medium, greater than 40 pbw water, more typically, greater than 50 pbw water. The aqueous medium may, optionally, further comprise water-soluble or water miscible components dissolved in the aqueous medium. The terminology “water miscible” as used herein means miscible in all proportions with water. Suitable water miscible organic liquids include, for example, (C₁-C₆)alcohols, such as methanol, ethanol, propanol, and (C₁-C₆)polyols, such as glycerol, ethylene glycol, propylene glycol, and diethylene glycol, The composition of the present invention may, optionally, further comprise one or more water insoluble or water immiscible components, such as a water immiscible organic liquid, wherein the combined aqueous medium and water insoluble or water immiscible components form a micro emulsion, or a multi-phase system such as, for example, an emulsion, a suspension or a suspo-emulsion, in which the aqueous medium is in the form of a discontinuous phase dispersed in a continuous phase of the water insoluble or water immiscible component, or, more typically, the water insoluble or water immiscible component is in the form of a discontinuous phase dispersed in a continuous phase of the aqueous medium.

As used herein, the term “hydration” in reference to the water-soluble polymer component of the present invention means association of substituent groups, typically hydrophilic subsitutent groups, such as hydroxyl groups, of the water-soluble polymer with water molecules, such as water molecules of the aqueous medium through, for example, hydrogen bonding. The degree to which the water-soluble polymer is hydrated can range from non-hydrated to completely hydrated, with degrees of partial hydration extending between the two extremes. As discussed more fully below, the water-soluble polymer is capable of contributing to the viscosity of the composition of the present invention with the magnitude of the contribution being dependent on the degree of hydration of the water-soluble polymer. The degree of hydration of the water-soluble polymer can thus be characterized based on the magnitude of the contribution that the water-soluble polymer makes to the viscosity of the composition.

As referred to herein a “non-hydrated” water-soluble polymer makes no significant contribution to the viscosity of the composition. In general, the non-hydrated water-soluble polymer would be in the form of a discontinuous phase, for example, discrete particles, that is dispersed in a continuous phase of the liquid medium, ideally with no interaction between the hydrophilic substituents of the polymer and any water molecules present in the liquid medium. In the case of an aqueous medium, there will generally be at least some interaction between the hydrophilic groups of polymer and water molecules of the aqueous medium at interfaces between the phases, for example, at the outer surfaces of the particles. It is believed that in the case of a non-hydrated water-soluble polymer, interaction among the hydrophilic substituent groups of the non-hydrated water-soluble polymer dominates over interaction between the hydrophilic substituent groups of the polymer and any water molecules present in the aqueous medium, the polymer chains of the non-hydrated water-soluble polymer are in a compact, folded conformation, and, in the case where the liquid medium is an aqueous medium, the non-hydrated water-soluble polymer is not dissolved in the aqueous medium and remains in the form of a discontinuous phase dispersed in the continuous phase of the aqueous medium.

As referred to herein, a “completely hydrated” water-soluble polymer makes the maximum contribution to the viscosity of the composition that the water-soluble polymer is capable of making. Without being bound by theory, it is believed that in a completely hydrated water-soluble polymer, association between the hydrophilic substituent groups of the water-soluble polymer and water molecules dominates over interaction among the hydrophilic substituent groups, that the polymer chains of a completely hydrated water-soluble polymer are thus in an unfolded, random coil conformation, and in the case where the liquid medium is an aqueous medium, the aqueous medium and completely hydrated water-soluble polymer form a single phase, that is, the completely hydrated water-soluble polymer is dissolved in the aqueous medium.

As referred to herein, a “partially hydrated” water-soluble polymer is a water-soluble polymer wherein some of the hydrophilic substituent groups of the polymer are associated with water molecules. At a relatively low level of hydration, the partially hydrated water-soluble polymer makes a relatively small contribution to the viscosity of the composition, while at a relatively high level of hydration, the viscosity contribution of a given amount of a partially hydrated water-soluble polymer in a given medium approaches, but is less than, the maximum contribution that the amount of water-soluble polymer is capable of making in that medium when completely hydrated. Without being bound by theory, it is believed that with increasing hydration, particles of the water-soluble polymer swell, an increasing number of hydrophilic substituent groups of the water-soluble polymer, including hydrophilic substituent groups within the mass of swollen water-soluble polymer, become associated with water molecules, and, as complete hydration is approached, the water-soluble polymer chains progressively unfold and approach an unfolded, randomly coiled configuration.

“Non-hydrated” and “partially hydrated” are collectively referred to herein as “incompletely hydrated”.

The degree of hydration of the water-soluble polymer can be characterized by viscosity measurements. For example, the viscosity of a given amount of a water-soluble polymer, in a given amount of an aqueous medium, in the presence of a given amount of a proposed hydration inhibitor component, and under given shear conditions, as described in more detail below (the “test composition”), can be compared to the viscosity of the same amount of the water-soluble polymer in the same amount of the aqueous medium in the absence of the proposed hydration inhibitor component (the “baseline composition”). If the viscosity of the test composition is equal to that of the baseline composition, then the water-soluble polymer of the test composition is deemed to be completely hydrated (and the proposed hydration inhibitor component is ineffective in the amount tested to inhibit hydration of the polymer). If the viscosity of the test composition is less than that of the baseline composition, then the water-soluble polymer of the test composition is deemed to be incompletely hydrated (and the proposed hydration inhibitor component is effective in the amount tested to inhibit hydration of the polymer).

In one embodiment, the liquid medium is an aqueous liquid medium and at least a portion of the water-soluble polymer is in the form of particles of the water-soluble polymer. In one embodiment, the liquid medium is an aqueous liquid medium, at least a portion of the water-soluble polymer is in the form of particles of the water-soluble polymer, and at least a portion of such particles are dispersed, more typically suspended, in the aqueous liquid medium. The presence of such particles in the composition of the present invention may be detected by, for example, optical microscopy.

In one embodiment, the composition of the present invention exhibits a viscosity of less than 10 Pa·s, more typically from about 0.1 to less than 10 Pa·s, and even more typically from about 0.1 to less than 5 Pa·s, at a shear rate of greater than or equal to 10 s⁻¹.

In one embodiment, the composition of the present invention exhibits a non-Newtonian “shear thinning” viscosity, that is, a viscosity that, within a given range of shear stress, decreases with increasing shear stress. Two general generally recognized categories of flow behavior, that is, plastic flow behavior and pseudoplastic flow behavior, each include shear thinning flow behavior.

In one embodiment, the composition of the present invention exhibits plastic flow behavior. As used herein, the term “plastic” in reference to flow behavior of a composition means the composition that exhibits a characteristic “yield strength”, that is, a minimum shear stress required to initiate flow of the composition, and exhibits shear thinning behavior over some range of shear stress above the yield strength. A plastic composition exhibits no flow when subjected to shear stress below its yield strength, and flows when subjected to shear stress above its yield strength, wherein, over an intermediate range of shear stress above its yield strength, the composition typically exhibits a non-Newtonian viscosity that decreases with increasing shear stress, that is, shear thinning behavior, and, at shear stresses above the intermediate range of shear stress, the composition may exhibit a viscosity that does not vary with shear stress, that is, Newtonian flow behavior.

In one embodiment the composition of the present invention exhibits pseudoplastic flow behavior. As used herein, the term “pseudoplastic” in reference to the flow behavior of a composition means that the composition exhibits a viscosity that decreases with increasing shear stress, that is, shear thinning behavior.

In each case, a composition having plastic or pseudoplastic rheological properties resists flow at low shear stress, but that when subjected to an elevated shear stress, such as being shaken in a bottle or squeezed through an orifice, the composition flows and can be easily pumped, poured, or otherwise dispensed from a container. In general, sedimentation or storage condition is a low shear process, having a shear rate in the range of from about 10⁻⁶ reciprocal seconds (1/s or, equivalently, s⁻¹) to about 0.01 s⁻¹ and pumping or pouring is a relatively high shear process with a shear rate in the range of greater than or equal to about 1 s⁻¹, more typically from 100 s⁻¹ to 10,000 s⁻¹, and even more typically, from 100 s⁻¹ to 1,000 s⁻¹.

In one embodiment, the suspending agent is selected from xanthan, silica, more typically fumed silica, inorganic colloidal or colloid-forming particles, more typically clays, rheology modifier polymers, and mixtures thereof. In one embodiment, wherein the liquid medium is an aqueous medium, the suspending agent comprises a polysaccharide polymer that differs from the water-soluble polymer (typically guar or derivatized guar) and that is more readily hydrolyzed than the water-soluble polymer. For example, xanthan gum may be dissolved in an aqueous medium and used as a suspending agent to suspend incompletely hydrolyzed guar particles in the aqueous medium.

In one embodiment, wherein the liquid medium is an aqueous medium and the water-soluble polymer is incompletely hydrolyzed and itself performs the function of suspending agent by forming a water swollen, viscous mass, said viscous mass having a lower viscosity than would the same amount of the same water-soluble polymer in a fully hydrated state, and a separate suspending agent is not required.

In one embodiment, the composition of the present invention further comprises a hydration inhibitor component, typically dissolved in the liquid medium, in an amount effective to inhibit hydration of the water-soluble polysaccharide in the liquid medium so that the polysaccharide polymer component of the composition of the present invention is incompletely hydrated, generally in an amount, based on 100 pbw of the aqueous medium, of from greater than 0 to about 70 pbw, more typically from about 15 to about 60 pbw, and even more typically, from about 20 to about 50 pbw of the hydration inhibitor component. Use of a hydration inhibitor component is typically of most benefit in those embodiments of the composition of the present invention wherein the liquid medium is an aqueous medium.

In another embodiment, the hydration inhibitor component is present in an amount having a lower limit of, based on 100 pbw of aqueous solution, of 10 pbw, or in another embodiment of 15 pbw, or in another embodiment, 20 pbw, or in another embodiment, 25 pbw.

In a further embodiment, the hydration inhibitor component is present in an amount having an upper limit of, based on 100 pbw of aqueous solution, of 30 pbw, or in another embodiment of 40 pbw, or in another embodiment, 50 pbw, or in another embodiment, 60 pbw, or in another embodiment, 70 pbw.

In one embodiment, the hydration inhibitor component is selected from comprising glycols; glycol derivatives, including, but not limited to, polyethylene glycols and polypropylene glycols; choline chloride; dibasic potassium phosphate; or any combination thereof.

The hydration inhibitor component can also comprise in other embodiments, surfactants, water-soluble non-surfactant salts, water dispersible organic solvents, and mixtures thereof. The terminology “non-surfactant salts” as used herein means salts that are not anionic, cationic, zwitterionic or amphoteric surfactants and includes active ingredients, such as a pesticidal active ingredient or a pharmaceutical active ingredient, that are salts and whose primary activity is other than modification of interfacial surface tension. The terminology “water dispersible organic solvents” includes water miscible organic liquids and water immiscible organic liquids that may be dispersed in water, such as for example, in the form of an emulsion of the water immiscible organic liquid in water.

It will be appreciated that the suspending agent and/or the hydration inhibitor component of the composition of the present invention may each perform more than one function. For example, solvent or surfactant compound that functions as a hydration inhibitor component in the composition of the present invention may also perform a desired function, for example, affect biological activity, in an end use application, such as a pharmaceutical or pesticide composition.

In one embodiment, the composition of the present invention comprises, based on 100 pbw of the composition, of from greater than 0 pbw, more typically from about 1 pbw, even more typically from about 2 pbw, and still more typically from greater than 2.5 pbw, to about 30 pbw, more typically to about 25, even more typically to about 20 pbw, and still more typically about 12 pbw, of the water-soluble polymer.

In another embodiment, the water-soluble polymer is present in an amount having a lower limit, based on 100 pbw of aqueous solution or composition, of 1 pbw, or in another embodiment of 1.2 pbw, or in another embodiment, 1.4 pbw, or in another embodiment, 1.6 pbw, or in another embodiment, 1.8 pbw, or in yet another further embodiment, 2 pbw, or in another embodiment, 2.4 pbw, or in a further embodiment, 3 pbw, or in another embodiment, 3.5 pbw, or in another embodiment, 3.8 pbw, or in another embodiment, 4 pbw, or in another embodiment, 4.5 pbw, or one embodiment, 5 pbw, or in another embodiment, 7 pbw, or in a further embodiment, 8 pbw, or in another embodiment, 10 pbw, or in yet another embodiment, 12 pbw, or in another embodiment, 16 pbw, or in another embodiment, 20 pbw. In one particular embodiment, the water-soluble polymer is present in an amount having a lower limit, based on 100 pbw of aqueous solution or composition, of 1.8 pbw. In one particular embodiment, the water-soluble polymer is present in an amount having a lower limit, based on 100 pbw of aqueous solution or composition, of 3.8 pbw. In one particular embodiment, the water-soluble polymer is present in an amount having a lower limit, based on 100 pbw of aqueous solution or composition, of 4 pbw. In one particular embodiment, the water-soluble polymer is present in an amount having a lower limit, based on 100 pbw of aqueous solution or composition, of 2 pbw.

In yet another embodiment, the water-soluble polymer is present in an amount having am upper limit, based on 100 pbw of aqueous solution or composition, of 20 pbw, or in another embodiment of 18 pbw, or in another embodiment, 17 pbw, or in another embodiment, 16 pbw, or in another embodiment, 14 pbw, or in yet another further embodiment, 13 pbw, or in another embodiment, 12 pbw, or in a further embodiment, 10 pbw, or in another embodiment, 9 pbw, or in another embodiment, 8 pbw, or in another embodiment, 7 pbw, or in another embodiment, 6 pbw, or one embodiment, 5.5 pbw, or in another embodiment, 5 pbw, or in a further embodiment, 4.5 pbw, or in another embodiment, 3 pbw, or in yet another embodiment, 2.5 pbw, or in another embodiment, 2.2 pbw. In one particular embodiment, the water-soluble polymer is present in an amount having an upper limit, based on 100 pbw of aqueous solution or composition, of 12 pbw. In one particular embodiment, the water-soluble polymer is present in an amount having an upper limit, based on 100 pbw of aqueous solution or composition, of 8 pbw. In one particular embodiment, the water-soluble polymer is present in an amount having an upper limit, based on 100 pbw of aqueous solution or composition, of 20 pbw.

In one embodiment, the polymer is a polysaccharide polymer. Polysaccharide polymer typically have a large number of hydrophilic, typically, hydroxyl, substituent groups, per molecule, more typically one or more hydroxyl group per monomeric unit of the polysaccharide polymer.

In one embodiment, wherein the polysaccharide polymer is a polymer having a weight average molecular weight of up to about 10,000,000 grams per mole (g/mol) more typically of up to about 5,000,000 grams per mole, more typically from about 100,000 to about 4,000,000 g/mol, even more typically from about 500,000 to about 3,000,000 g/mol, the composition of the present invention comprises, based on 100 pbw of the composition, up to about 15 pbw, more typically from about 1 to about 12 pbw, and even more typically, from about 2 to about 10 pbw, and still more typically from greater than 2.5 to about 8 pbw, of the polysaccharide polymer. The weight average molecular weight of a polysaccharide polymer may be determined by known methods, such as by gel permeation chromatography with light scattering or refractive index detection. As generally used herein, i.e., in the absence of an explicit limitation such as “derivatized” or “non-derivatized”, the term “guar polymer” refers collectively to non-derivatized polysaccharide polymers and derivatized polysaccharide polymers.

In one embodiment, wherein the polysaccharide polymer is a depolymerized guar having a molecular weight of less than about 100,000 g/mol, the composition of the present invention comprises, based on 100 pbw of the composition, up to about 50 pbw or to about 30 pbw, more typically from about 0.1 pbw or from about 1 pbw to about 25 pbw, even more typically, from about 1.5 to about 20 pbw, still more typically from about 2 pbw to about 15 pbw, and still more typically greater than 2.5 pbw to about 12 pbw, of the polysaccharide polymer.

In one embodiment, the composition of the present invention comprises from greater than 2.5 to about 8 pbw of a guar polymer suspended in a liquid medium, more typically an aqueous medium, wherein the polymer has a weight average molecular weight of from about 100,000 g/mol, more typically from about 500,000 g/mol, to about 5,000,000 g/mol, more typically to about 4,000,000 g/mol, and even more typically to about 3,000,000 g/mol, and the composition exhibits a viscosity of greater than or equal to 5 Pa·s, more typically greater than or equal to 10 Pa·s, at a shear rate of less than 0.01 s⁻¹, more typically less than 0.001 s⁻¹, and a viscosity that is less than the viscosity exhibited at a shear rate of less than or equal to 0.01 s⁻¹, typically a viscosity of less than 10 Pa·s, more typically less than 5 Pa·s, at a shear rate of greater than 10 s⁻¹, more typically greater than 100 s⁻¹.

In one embodiment, the composition of the present invention comprises:
(a) a liquid medium,
(b) an incompletely hydrated water-soluble polymer, more typically wherein at least a portion of a water-soluble polymer is in the form of particles of the water-soluble polymer, at least a portion of which are dispersed, more typically suspended in the liquid medium, and
(c) a suspending agent in an amount effective to impart shear thinning properties to the composition;
(d) a hydration inhibitor component; and
(e) at least one pesticide.

In one embodiment, the liquid medium is an aqueous medium and composition of the present invention comprises, based on 100 pbw of the composition:
(a) greater than 0 pbw, more typically greater than or equal to about 10 pbw, even more typically greater than or equal to about 30 pbw, and still more typically greater than or equal to about 40 pbw water,
(b) from greater than 0 pbw, more typically from about 0.1 pbw or from about 1 pbw, more typically from about 1.5 pbw, even more typically from about 2 pbw, and still more typically from greater than 2.5 pbw, or from about 3 pbw or from about 4 pbw, to about 50 pbw or to about 30 pbw, more typically to about 25 pbw, more typically to about 20 pbw, even more typically to about 15 pbw, and still more typically, to about 12 pbw, of the incompletely hydrated water-soluble polysaccharide polymer, more typically wherein at least a portion of the water-soluble polymer is in the form of particles, and at least a portion of such particles are dispersed, more typically, suspended, in the liquid medium, and
(c) from greater than 0 pbw, more typically from about 0.1 pbw, even more typically from about 0.2 pbw, and still more typically from about 0.5 pbw, to about 10 pbw and, more typically, to about 5 pbw, of the suspending agent.

In one embodiment, the composition of the present invention comprises:
(a) an aqueous medium,
(b) an incompletely hydrated water-soluble polysaccharide polymer, more typically wherein at least a portion of a water-soluble polymer is in the form of particles of the water-soluble polymer, at least a portion of which are dispersed, more typically suspended in the aqueous medium,
(c) a suspending agent in an amount effective to impart shear thinning properties to the composition, and
(d) a hydration inhibitor component in an amount effective to inhibit hydration of the water-soluble polysaccharide in the aqueous medium.

In one embodiment, the composition of the present invention comprises, based on 100 pbw of the composition:
(a) greater than 0 pbw, more typically greater than or equal to about 10 pbw, even more typically greater than or equal to about 30 pbw, and still more typically greater than or equal to about 40 pbw, water,
(b) from greater than 0 pbw, more typically from about 0.1 pbw or from about 1 pbw, more typically from about 1.5 pbw, even more typically from about 2 pbw, and still more typically from greater than 2.5 pbw, or from about 3 pbw or from about 4 pbw, to about 50 pbw or to about 30 pbw, more typically to about 25 pbw, more typically to about 20 pbw, even more typically, to about 15 pbw, and still more typically, to about 12 pbw, of the incompletely hydrated polysaccharide polymer, more typically wherein at least a portion of the water-soluble polymer is in the form of particles, and at least a portion of such particles are dispersed, more typically, suspended, in the liquid medium,
(c) from greater than 0 pbw, more typically from about 0.1 pbw, even more typically from about 0.2 pbw, and still more typically from about 0.5 pbw, to about 10 pbw and, and more typically to about 5 pbw, of the suspending agent, and
(d) from greater than 0 pbw, more typically from about 10 pbw, even more typically from about 15 pbw, and still more typically from about 20 pbw, to about 70 pbw, more typically to about 60 pbw, and even more typically to about 50 pbw, of the hydration inhibitor component.

In one embodiment, the composition of the present invention comprises, based on 100 pbw of the composition:
(a) greater than 0 pbw, more typically greater than or equal to about 10 pbw, even more typically greater than or equal to about 30 pbw, and still more typically greater than or equal to about 40 pbw, water,
(b) from greater than 0 or from about 0.1 pbw to about 50 pbw or to about 30 pbw, more typically from about 1 to about 25 pbw, more typically, from about 1.5 to about 20 pbw, even more typically, from about 2 to about 15 pbw, and still more typically from greater than 2.5 to about 12 pbw, of the incompletely hydrated polysaccharide polymer, more typically wherein at least a portion of the water-soluble polymer is in the form of particles, and at least a portion of such particles are dispersed, more typically, suspended, in the liquid medium,
(c) from greater than 0 to about 10 pbw, more typically from about 0.1 to about 10 pbw, even more typically from about 0.2 to about 5 pbw, and still more typically, from about 0.5 to about 5 pbw, of the suspending agent, and
(d) from greater than 0 to about 70 pbw, more typically from about 10 to about 70 pbw, even more typically from about 15 to about 60 pbw, and still more typically from about 20 to about 50 pbw, of the hydration inhibitor component.

In one embodiment, the suspending agent is fume silica, and the hydration inhibitor component is glycerin, a glycol or a glycol derivative or a mixture thereof. The hydration inhibitor component can comprise a non- surfactant salt, a surfactant, a water dispersible organic solvent, a mixture of a non-surfactant salt and a surfactant, a mixture of a non-surfactant salt and a water dispersible organic solvent, or a mixture of a non-surfactant salt, a surfactant, and a water dispersible organic solvent.

In one embodiment, glycol derivatives include but are not limited to polypropylene glycol, triethylene glycol, glycol alkyl ethers such as dipropylene glycol methyl ether, diethylene glycol,

In one embodiment, the suspending agent is xanthan and the hydration inhibitor component is choline chloride or a choline salt. In one embodiment, the hydration inhibitor component is polyethylene glycol (PEG), choline chloride or a mixture thereof.

In one embodiment, the suspending agent further comprises silica and/or clay

In one embodiment, the composition of the present invention comprises, based on 100 pbw of the composition:

from greater than 0 pbw, or greater than or equal to about 10 pbw, of or greater than or equal about 30 pbw of an aqueous medium, more typically water or a mixture of water and a water miscible organic liquid,

from greater than 2.5 pbw, or from about 3 pbw, or from about 4 pbw to about 50 pbw, or to about 30 pbw, or to about 25 pbw, or to about 20 pbw, or to about 15 pbw, or to about 12 pbw, of a water-soluble polymer, more typically a water-soluble polymer selected from water-soluble polysaccharide polymers and water-soluble non-polysaccharide polymers, and even more typically a water-soluble polymer selected from polyacrylamide polymers, non-derivatized guars, derivatized guars, and mixtures thereof, wherein such water-soluble polymer is incompletely hydrated, more typically wherein at least a portion of the water-soluble polymer is in the form of particles and at least a portion of such particles are dispersed, more typically, suspended, in the liquid medium,

from 0 pbw, or from greater than 0 pbw, or from about 0.1 pbw, or from about 0.2 pbw, or from about 0.5 pbw, to about 10 pbw, or to about 5 pbw, of a suspending agent, more typically of a suspending agent selected from silicas, inorganic colloidal or colloid-forming particles, rheology modifier polymers, water-soluble polymers other than the water-soluble polymer, preferably xanthan, and mixtures thereof dissolved or dispersed in the liquid medium, and

from 0 pbw, or from greater than 0 pbw, or from about 2 pbw, or from about 5 pbw, to about 30 pbw or to about 15 pbw, or to about 10 pbw, of a hydration inhibitor component, more typically a hydration inhibitor component selected from surfactants, water-soluble non-surfactant salts, water dispersible organic solvents, and mixtures thereof, preferably polyethylene glycol (PEG), dissolved or dispersed in the liquid medium.

In one embodiment, the composition of the present invention comprises, based on 100 parts by weight of the composition:

from greater than 0 pbw, or greater than or equal to about 10 pbw, or greater than or equal to about 30 pbw of a non-aqueous liquid medium, more typically of a water immiscible organic liquid,

from greater than 0 pbw, or from about 0.1 pbw, or from about 1 pbw, or from about 1.5 pbw, or from about 2 pbw, or from greater than 2.5 pbw, or from about 4 pbw, to about 50 pbw , or to about 30 pbw, or to about 25 pbw, or to about 20 pbw, or to about 15 pbw, or to about 12 pbw, of a water-soluble polymer, more typically a water-soluble polymer selected from water-soluble polysaccharide polymers and water-soluble non-polysaccharide polymers, and even more typically a water-soluble polymer selected from polyacrylamide polymers, non-derivatized guars, derivatized guars, and mixtures thereof, wherein at least a portion of the water-soluble polymer is in the form of particles and at least a portion of such particles are dispersed, more typically, suspended, in the non-aqueous liquid medium, and from 0 pbw, or from greater than 0 pbw, or from about 0.1 pbw, or from about 0.2 pbw, or from about 0.5 pbw, to about 10 pbw or to about 5 pbw, of a suspending agent, more typically xanthan. In such embodiment, the suspending agent is different than the water-soluble polysaccharide polymer.

Suitable water-soluble polysaccharide polymers are include, for example, galactomannans such as guars, including guar derivatives, xanthans, polyfructoses such as levan, starches, including starch derivatives, such as amylopectin, and cellulose, including cellulose derivatives, such as methylcellulose, ethylcellulose, carboxymethylcellulose, hydroxyethylcellulose, cellulose acetate, cellulose acetate butyrate, and cellulose acetate propionate.

Galactomannans are polysaccharides consisting mainly of the monosaccharides mannose and galactose. The mannose-elements form a chain consisting of many hundreds of (1,4)-β-D-mannopyranosyl-residues, with 1,6 linked α-D-galactopyranosyl-residues at varying distances, dependent on the plant of origin. Naturally occurring galactomannans are available from numerous sources, including guar gum, guar splits, locust bean gum and tara gum. Additionally, galactomannans may also be obtained by classical synthetic routes or may be obtained by chemical modification of naturally occurring galactomannans.

Guar gum refers to the mucilage found in the seed of the leguminous plant Cyamopsis tetragonolobus. The water-soluble fraction (85%) is called “guaran,” which consists of linear chains of (1,4)-β-D mannopyranosyl units-with α-D-galactopyranosyl units attached by (1,6) linkages. The ratio of D-galactose to D-mannose in guaran is about 1:2. Guar gum typically has a weight average molecular weight of between 2,000,000 and 5,000,000 g/mol. Guars having a reduced molecular weight, such as for example, from about 50,000 to about 2,000,000 g/mol are also known.

Guar seeds are composed of a pair of tough, non-brittle endosperm sections, hereafter referred to as “guar splits,” between which is sandwiched the brittle embryo (germ). After dehulling, the seeds are split, the germ (43-47% of the seed) is removed by screening, and the splits are ground. The ground splits are reported to contain about 78-82% galactomannan polysaccharide and minor amounts of some proteinaceous material, inorganic non-surfactant salts, water-insoluble gum, and cell membranes, as well as some residual seedcoat and embryo.

In one aspect, the guar or guar derivative is native guar, carboxymethyl guar, carboxymethylhydroxypropyl guar, cationic hydroxypropyl guar, hydroxyalkyl guar, including hydroxyethyl guar, hydroxypropyl guar, hydroxybutyl guar and higher hydroxylalkyl guars, carboxylalkyl guars, including carboxymethyl guar, carboxylpropyl guar, carboxybutyl guar, and higher carboxyalkyl guars, the hydroxyethylated, hydroxypropylated and carboxymethylated derivative of guaran, the hydroxethylated and carboxymethylated derivatives of carubin, and the hydroxypropylated and carboxymethylated derivatives of cassia-gum. In one embodiment, the derivatized guar is hydroxypropyl guar. In one embodiment, the derivatized guar is cationic hydroxypropyl guar or cationic guar.

In one embodiment, the guar or guar derivative comprises: (native) guar, hydroxypropyl guar gum, carboxymethyl guar gum, carboxymethylhydroxypropyl guar gum, and a combination of any of the foregoing. In another embodiment, the guar derivative is guar hydroxypropyl trimonium chloride, hydroxypropyl guar hydroxypropyl trimonium chloride or any combination thereof

In another embodiment, the guar or guar derivative comprises: guar, unwashed guar gum, washed guar gum, carboxymethyl guar (CM guar), hydroxyethyl guar (HE guar), hydroxypropyl guar (HP guar), carboxymethylhydroxypropyl guar (CMHP guar), cationic guar, hydrophobically modified guar (HM guar), hydrophobically modified carboxymethyl guar (HMCM guar), hydrophobically modified hydroxyethyl guar (HMHE guar), hydrophobically modified hydroxypropyl guar (HMHP guar), cationic hydrophobically modified hydroxypropyl guar (cationic HMHP guar), hydrophobically modified carboxymethylhydroxypropyl guar (HMCMHP guar), hydrophobically modified cationic guar (HM cationic guar), guar hydroxypropyl trimonium chloride, hydroxypropyl guar hydroxypropyl trimonium chloride. In one embodiment the guar or a guar derivative is a hydroxypropyl guar or a natural guar.

Levan is a polyfructose comprising 5-membered rings linked through β-2,6 bonds, with branching through β-2,1 bonds. Levan exhibits a glass transition temperature of 138° C. and is available in particulate form. At a molecular weight of 1-2 million, the diameter of the densely-packed spherulitic particles is about 85 nm.

Modified celluloses are celluloses containing at least one functional group, such as a hydroxy group, hydroxycarboxyl group, or hydroxyalkyl group, such as for example, hydroxymethyl cellulose, hydroxyethyl celluloses, hydroxypropyl celluloses or hydroxybutyl celluloses.

Processes for making derivatives of guar gum splits are generally known. Typically, guar splits are reacted with one or more derivatizing agents under appropriate reaction conditions to produce a guar polysaccharide having the desired substituent groups. Suitable derivatizing reagents are commercially available and typically contain a reactive functional group, such as an epoxy group, a chlorohydrin group, or an ethylenically unsaturated group, and at least one other substituent group, such as a cationic, nonionic or anionic substituent group, or a precursor of such a substituent group per molecule, wherein substituent group may be linked to the reactive functional group of the derivatizing agent by bivalent linking group, such as an alkylene or oxyalkylene group. Suitable cationic substituent groups include primary, secondary, or tertiary amino groups or quaternary ammonium, sulfonium, or phosphinium groups. Suitable nonionic substituent groups include hydroxyalkyl groups, such as hydroxypropyl groups. Suitable anionic groups include carboxyalkyl groups, such as carboxymethyl groups. The cationic, nonionic and/or anionic substituent groups may be introduced to the guar polysaccharide chains via a series of reactions or by simultaneous reactions with the respective appropriate derivatizing agents.

The guar may be treated with a crosslinking agent, such for example, borax (sodium tetra borate) is commonly used as a processing aid in the reaction step of the water-splits process to partially crosslink the surface of the guar splits and thereby reduces the amount of water absorbed by the guar splits during processing. Other crosslinkers, such as, for example, glyoxal or titanate compounds, are known.

In one embodiment, the polysaccharide component of the composition of the present invention is a non-derivatized galactomannan polysaccharide, more typically a non-derivatized guar gum.

In one embodiment, the polysaccharide is a derivatized galactomannan polysaccharide that is substituted at one or more sites of the polysaccharide with a substituent group that is independently selected for each site from the group consisting of cationic substituent groups, nonionic substituent groups, and anionic substituent groups.

In one embodiment, the polysaccharide component of the composition of the present invention is derivatized galactomannan polysaccharide, more typically a derivatized guar. Suitable derivatized guars include, for example, hydroxypropyl trimethylammonium guar, hydroxypropyl lauryldimethylammonium guar, hydroxypropyl stearyldimethylammonium guar, hydroxypropyl guar, carboxymethyl guar, guar with hydroxypropyl groups and hydroxypropyl trimethylammonium groups, guar with carboxymethyl hydroxypropyl groups and mixtures thereof.

The amount of derivatizing groups in a derivatized polysaccharide polymer may be characterized by the degree of substitution of the derivatized polysaccharide polymer or the molar substitution of the derivatized polysaccharide polymer.

As used herein, the terminology “degree of substitution” in reference to a given type of derivatizing group and a given polysaccharide polymer means the number of the average number of such derivatizing groups attached to each monomeric unit of the polysaccharide polymer. In one embodiment, the derivatized galactomannan polysaccharide exhibits a total degree of substitution (“DS_{T}”) of from about 0.001 to about 3.0, wherein:

DS_{T} is the sum of the DS for cationic substituent groups (“DS_{cationic}”), the DS for nonionic substituent groups (“DS_{nonionic}”) and the DS for anionic substituent groups (“DS_{anionic}”),

DS_{cationic} is from 0 to about 3, more typically from about 0.001 to about 2.0, and even more typically from about 0.001 to about 1.0,

DS_{nonionic} is from 0 to 3.0, more typically from about 0.001 to about 2.5, and even more typically from about 0.001 to about 1.0, and

DS_{anionic} is from 0 to 3.0, more typically from about 0.001 to about 2.0.

As used herein, the term “molar substitution” or “ms” refers to the number of moles of derivatizing groups per moles of monosaccharide units of the guar. The molar substitution can be determined by the Zeisel-GC method. The molar substitution utilized by the present invention is typically in the range of from about 0.001 to about 3.

In one embodiment, the polysaccharide polymer is in the form of particles. In one embodiment, the particles of polysaccharide polymer have an initial, that is, determined for dry particles prior to suspension in the aqueous medium, average particle size of about 5 to 200 μm, more typically about 20 to 200 μm as measured by light scattering, and exhibit a particle size in the aqueous medium of greater than or equal to the initial particle size, that is greater than or equal to 5 μm, more typically greater or equal to than 20 μm, with any increase from the initial particle size being due to swelling brought about by partial hydration of the polysaccharide polymer in the aqueous medium.

In one embodiment, the suspending agent component of the composition of the present invention comprises xanthan, in an amount that is effective, either alone or in combination with one or more other suspending agents (such as, for example, silica or clay), to impart shear thinning viscosity to the composition, typically in an amount, based on 100 pbw of the composition, of from greater than 0 pbw, more typically from about 0.1 pbw, and even more typically from about 0.5 pbw, to about 10 pbw, more typically to about 5 pbw, and even more typically to about 2.5 pbw, of xanthan.

In one embodiment, the composition of the present invention comprises, based on 100 pbw of the composition, from greater than 0 to about 10 pbw, more typically from about 0.1 to about 5 pbw, and even more typically from about 0.5 to about 2.5 pbw, of xanthan.

In one embodiment, the suspending agent component of the composition of the present invention can further comprise an inorganic, typically aluminosilicate or magnesium silicate, colloid-forming clay, typically, a smectite (also known as montmorillonoid) clay, an attapulgite (also known as palygorskite) clay, or a mixture thereof. These clay materials can be described as expandable layered clays, wherein the term “expandable” as used herein in reference to such clay relates to the ability of the layered clay structure to be swollen, or expanded, on contact with water.

In one embodiment, the hydration inhibitor component of the composition of the present invention comprises an organic solvent, typically, glycol, glycerin, or a glycol derivative, typically, PEG.

In one embodiment, the hydration inhibitor component of the composition of the present invention comprises a glycol or glycol derivative in an amount that is effective, either alone or in combination with one or more other hydration inhibitor components, to prevent or to at least inhibit hydration of the polysaccharide, typically in an amount, based on 100 pbw of the composition, of from greater than 0 pbw, more typically from about 2 pbw, and even more typically from about 5 pbw, to about 60 pbw, more typically to about 50 pbw, and even more typically, to about 40 pbw, of surfactant.

In one embodiment, the composition of the present invention comprises, based on 100 pbw of the composition, from greater than 0 to about 60 pbw, more typically from about 2 to about 50 pbw, and even more typically, from about 5 to about 40 pbw, of glycol or glycol derivative.

In one embodiment, the hydration inhibitor component as described herein can further comprise choline chloride, potassium phosphate (dibasic), or a combination thereof. In another embodiment, the hydration inhibitor component further comprises a water-soluble non-surfactant salt. Suitable water-soluble non-surfactant salts include organic non-surfactant salts, inorganic non-surfactant salts, and mixtures thereof, as well as polyelectrolytes, such as uncapped polyacrylates, polymaleates, or polycarboxylates, lignin sulfonates or naphthalene sulfonate formaldehyde copolymers. The water-soluble non-surfactant salt comprises a cationic component and an anionic component.

Suitable pesticides are biologically active compounds used to control agricultural pests and include, for example, herbicides, plant growth regulators, crop dessicants, fungicides, bacteriocides, bacteriostats, insecticides, and insect repellents, as well as their water soluble salts and esters. Suitable pesticides include, for example, aryloxyphenoxy-propionate herbicides, such as haloxyfop, cyhalofop, and quizalofop, triazine herbicides such as metribuzin, hexaxinone, or atrazine; sulfonylurea herbicides such as chlorsulfuron; uracils such as lenacil, bromacil, or terbacil; urea herbicides such as linuron, diuron, siduron, or neburon; acetanilide herbicides such as alachlor, or metolachlor; thiocarbamate herbicides such as benthiocarb, triallate; oxadiazolone herbicides such as oxadiazon; isoxazolidone herbicides, phenoxy carboxylic acid herbicides such as dichlorophenoxyacetic acid (“2,4-D”), dichlorophenoxybutanoic acid (“2,4-DB”), 2-methyl-4-chlorophenoxyacetic acid (“MCPA”), 4-(4-chloro-2-methylphenoxy) butanoic acid (“MCPB”), dichlorprop, and mecoprop, diphenyl ether herbicides such as fluazifop, acifluorfen, bifenox, or oxyfluorfen; dinitro aniline herbicides such as trifluralin; organophosphonate herbicides such as glufosinate salts and esters and glyphosate salts and esters; dihalobenzonitrile herbicides such as bromoxynil, or ioxynil, benzoic acid herbicides such as dicamba, dipyridilium herbicides such as paraquat, and pyridine and pyridineoxy carboxylic acid herbicides such as clopyralid, fluroxypyr, picloram, triclopyr, and aminopyralid. Suitable fungicides include, for example, nitrilo oxime fungicides such as cymoxanil; imidazole fungicides such as benomyl, carbendazim, or thiophanate-methyl, triazole fungicides such as triadimefon; sulfenamide fungicides, such as captan; dithio-carbamate fungicides such as maneb, mancozeb, or thiram; chloronated aromatic fungicides such as chloroneb; dichloro aniline fungicides such as iprodione, strobilurin fungicides such as kresoxim-methyl, trifloxystrobin or azoxystrobin; chlorothalonil; copper salt fungicides such as copper oxychloride; sulfur; phenylamides; and acylamino fungicides such as metalaxyl or mefenoxam. Suitable insecticides, include, for example, carbamate insecticides, such as methomyl, carbaryl, carbofuran, or aldicarb; organo thiophosphate insecticides such as EPN, isofenphos, isoxathion, chlorpyrifos, or chlormephos; organophosphate insecticides such as terbufos, monocrotophos, or terachlorvinphos; perchlorinated organic insecticides such as methoxychlor; synthetic pyrethroid insecticides such as fenvalerate, abamectin or emamectin benzoate, neonicotinoide insecticides such as thiamethoxam or imidacloprid; pyrethroid insecticides such as lambda-cyhalothrin, cypermethrin or bifenthrin, and oxadiazine insecticides such as indoxacarb, imidachlopryd, or fipronil. Suitable miticides include, for example, propynyl sulfite miticides such as propargite; triazapentadiene miticides such as amitraz; chlorinated aromatic miticides such as chlorobenzilate, or tetradifan; and dinitrophenol miticides such as binapacryl. Suitable nematicides include carbamate nematicides, such as oxamyl. It is understood that non-pesticide choline salts excludes any choline salts of the aforementioned pesticides, including in particular, herbicides.

Pesticide compounds are, in general, referred herein to by the names assigned by the International Organization for Standardization (ISO). ISO common names may be cross-referenced to International Union of Pure and Applied Chemistry (“IUPAC”) and Chemical Abstracts Service (“CAS”) names through a number of sources.

In one embodiment, the pesticide composition comprises one or more auxinic herbicides, more typically, one or more auxinic herbicides selected from clopyralid, triclopyr, 2,4-D, 2,4-DB, MCPA, MCPB, dicamba, aminopyralid and picloram, and their respective water soluble salts and esters.

In one embodiment, the pesticide comprises one or more herbicide compounds selected from glyphosate, clopyralid, triclopyr, 2,4-D, 2,4-DB, MCPA, MCPB, dicamba, aminopyralid and picloram, their respective water soluble salts and esters, and mixtures thereof, more typically a mixture of water soluble salts of glyphosate and clopyralid, triclopyr, 2,4-D, 2,4-DB, MCPA, MCPB, dicamba, aminopyralid or picloram, even more typically, a mixture of water soluble salts of glyphosate and triclopyr, 2,4-D, or dicamba. In one particular embodiment, the pesticide comprises one or more herbicide compounds, specifically, a mixture of (i) one or more water soluble salts of glyphosate and (ii) one or more water soluble salts of dicamba. In another particular embodiment, the pesticide comprises one or more herbicide compounds, specifically, a mixture of (i) one or more water soluble salts of 2,4-D and (ii) one or more water soluble salts of dicamba.

The venturi compartment typically comprises a longitudinally extending throughhole with an inlet opening in fluid communication with an outlet opening and a venturi section interposed and in fluid communication with said inlet opening and said outlet opening. In one embodiment, the venturi section tapers in a constricting manner from inlet opening to constrict the flow of fluid therethrough, to cause the velocity of the fluid to increase and the pressure of the fluid to decrease. The venturi section terminates at a venturi throat. The throughhole also comprises an expansion section which is disposed downstream from venturi section, and between the venturi section and outlet opening. The expansion section allows the fluid which flows through venturi section to expand on the downstream side of venturi throat. The venturi compartment includes at least one venturi induction port that is in fluid communication with the throughhole. In this manner, as a first fluid (e.g., a pesticide formulation) flows through the venturi compartment throughhole, a vacuum is created in connection with the venturi induction port that draws in a second fluid (e.g., air) for combining with the first fluid to form a fluid mixture prior to exiting the nozzle.

In one embodiment, the venturi compartment comprises at least one induction ports. Typically, each induction port has an inlet in fluid communication with a second fluid, typically air, and an opposite end which extends to and terminates at the throughhole of venturi compartment. In one embodiment, each induction port transports the second fluid from into the throughhole of the venturi compartment for mixing with the first fluid transported through venturi throat.

In one embodiment, the induction flat spray tip nozzle comprises a nozzle body and a discharge orifice. The nozzle body includes an inlet end for connection to a pressurized liquid supply. In one embodiment, the nozzle body comprises at least one compartment, which in certain embodiments, is a venturi compartment. In other embodiments, the nozzle body comprises a first fluid compartment having a first longitudinal axis, a second fluid compartment having a second longitudinal axis, and a venturi compartment. In other embodiments, the nozzle body comprises a first fluid compartment having a first longitudinal axis, a second fluid compartment having a second longitudinal axis, a third fluid compartment having a third longitudinal axis, and a venturi compartment. In one embodiment, the venturi compartment is interposed between and in fluid communication with the first fluid compartment and the second fluid compartment. The venturi throat, in some embodiments, has a diameter less than the diameter of said first and second compartment. The venturi throat is in fluid communication between said first compartment and second compartment.

In yet another embodiment, the venturi compartment comprises a first fluid compartment having a first longitudinal axis and a second fluid compartment having a second longitudinal axis. In such embodiment, the venturi section is interposed between and in fluid communication with the first fluid compartment and the second fluid compartment. In one embodiment, the venturi section has a diameter that is less than the diameter of the first compartment and less than the diameter of the second compartment. In another embodiment, the venturi section has a diameter that is less than the diameter of the first compartment and less than the diameter of the second compartment and/or less than the diameter of the third compartment.

In one embodiment, the nozzle body includes a second cylindrical fluid compartment in fluid communication with a first fluid compartment (having a first longitudinal axis) and having a second longitudinal axis that extends transversely relative to the first longitudinal axis.

The nozzle body, in alternative embodiments, has a pre-orifice less than the diameter of said first and second compartment in fluid communication between said first compartment and second compartment.

In another embodiment, the nozzle body has at least one discharge orifices communicating with the first or second compartment, the discharge orifice optionally having a discharge surface for directing liquid discharging from the second chamber. The discharge surface, in certain embodiments, directs fluid or a fluid mix from said second chamber with a controlled liquid spray distribution. In one particular embodiment, the fluid mix is air and a pesticide composition.

Some examples of nozzles are as follows: low-drift nozzles (e.g., Drift Guard™—Spraying Systems, Rain Drop Fan™—Delavan) are designed to create larger droplets at the same flow rate and operating pressure than comparable standard flat-fan nozzles. Typically, this is accomplished by adding a “pre-orifice” to the nozzle tip assembly just ahead of the conventional discharge orifice, producing an average droplet size of 300 to 400 microns. Turbo TeeJet™ Nozzle Spraying Systems Co. incorporates a flat-fan nozzle (Turbo TeeJet™) that can be used for the same purposes as a standard flat-fan nozzle. The advantages are that such nozzles can be operated at a wider range of pressures 15 to 90 psi, and produce fewer drift-prone droplets compared to the same size of a standard flat fan. A hybrid between standard flat fan spray tips and the clog-free flooding nozzles, certain nozzles such as the Turbo TeeJet™ have a pre-orifice at the tip that slows liquid velocity. The resulting larger droplets are less likely to drift but still provide good coverage with a uniform spray pattern. Air-Assist Nozzles: are TurboDrop™ (Greenleaf Technologies), AI TeeJet™ (Spraying Systems) and Raindrop Ultra™ (Delavan) These nozzles are designed to produce larger droplets while at the same time reducing the percentage of fine droplets. Air-assisted nozzles contain a pressure reduction chamber with a narrow port used to draw air into this pressure chamber, e.g., venturi port. As the liquid passes through the orifice plate, as a result of the pressure drop created by this venturi, air is sucked into the nozzle body. In the mixing chamber, air and spray solutions are blended much like a water aspirator and, when the liquid is discharged from the nozzle tip, droplets filled with air are produced. Upon exiting the nozzle orifice, the air included in the nozzle expands, which makes the size of droplets somewhat larger and causes an increase in velocity of droplets. In addition to the large droplets having a higher velocity, the nozzles further improves the chances the droplet will reach the target before becoming subject to drift. As additional benefit of this nozzle is that the large droplets shatter and splatter on contact, causing the small air-filled drops to spread out on the target for better coverage. These nozzles will produce an average droplet size of 400 to 600 microns. Total volume applied with these type nozzles should be rates above 15 gpa.

Spray particle size is important because it affects both efficacy and spray drift of the application of an herbicide, insecticide, or fungicide. If the size of the spray particle (for example, 250-500 microns) is doubled and the application volume stays the same, you have only one-eighth as many spray droplets. As an example, to gain optimum efficacy in weed control, a 10-20 gallons per acre (GPA) spray volume is typically recommended, with a “medium” droplet size suggested for contact nontranslocating herbicides, and a “coarse” droplet size suggested for contact translocating herbicides. Concern for drift may cause you to consider using larger droplet sizes and higher spray volumes. Nozzle Description Nozzle types commonly used in low-pressure agricultural sprayers include: fan, hollow-cone, full-cone, and others. Special features such as air induction (AI) and drift reducing (DG) are available for some nozzles.

As discussed, below, in one embodiment, the composition is a concentrated, dilutable form of an end use composition and further comprises one or more active ingredients, such as, for example, a pesticidal active ingredient, appropriate to the intended end use. Such active ingredients may be water-soluble non-surfactant salts. The amount of active ingredient that is a water-soluble non-surfactant salt is to be included in the total amount of water-soluble for purposes of determining the total amount of water-soluble salt component of the composition of the present invention.

In one embodiment, the composition of the present invention comprises a water-soluble salt in an amount that is effective, either alone or in combination with one or more other hydration inhibitor components, to prevent or to at least inhibit hydration of the polysaccharide, typically in an amount, based on 100 pbw of the composition and including the amount of any water-soluble non-surfactant salt, the amount of any of the surfactant component of the composition of the present invention that is a water-soluble salt and the amount of any of the active ingredient component of the composition of the present invention that is a water-soluble salt, of from greater than 0 pbw, more typically, from about 2 pbw and even more typically, from about 5 pbw, to about 70 pbw, more typically to about 65 pbw and even more typically, to about 60 pbw, of water-soluble salt.

In one embodiment, the composition of the present invention comprises, based on 100 pbw of the composition and including the amount of any water-soluble non-surfactant salt, the amount of any of the surfactant component of the composition of the present invention that is a water-soluble and the amount of any active ingredient component of the composition of the present invention that is a water-soluble salt, from greater than 0 to about 70 pbw, more typically, from about 2 to about 65 pbw and even more typically, from about 5 to about 60 pbw, of water-soluble salt.

In one embodiment, the hydration inhibitor component of the composition of the present invention comprises a water dispersible organic solvent. Suitable water dispersible organic solvents include, for example, (C₁-C₁₈)alcohols, such as, for example, monohydric alcohols, such as methanol, ethanol, isopropanol, cetyl alcohol, steelyl alcohol, benzyl Alcohol, oleyl alcohol, and polyhydric alcohols, such as, for example, 2-butoxyethanol, ethylene glycol, and glycerol, alkylether diols such as, for example, ethylene glycol monoethyl ether, propylene glycol monoethyl ether, and diethylene glycol monomethyl ether, and mixtures thereof.

In one embodiment, the hydration inhibitor component of the composition of the present invention comprises a water dispersible, more typically, water-soluble, organic solvent. Suitable water dispersible organic solvents include, for example, monohydric alcohols, polyhydric alcohols, alkylether diols, and mixtures thereof.

In one embodiment, the composition of the present invention comprises a water dispersible organic solvent, in an amount that is effective, either alone or in combination with one or more other hydration inhibitor components, to prevent or to at least inhibit hydration of the polysaccharide, typically in an amount, based on 100 pbw of the composition, of from greater than 0 pbw, more typically from about 2 pbw, and even more typically, from about 5 pbw to about 40 pbw, more typically to about 30 pbw, and even more typically to about 25 pbw, of water dispersible organic solvent.

In one embodiment, the composition of the present invention comprises, based on 100 pbw of the composition, from greater than 0 to about 40 pbw, more typically from about 2 to about 30 pbw, and even more typically, from about 5 to about 25 pbw, of water dispersible organic solvent.

The composition of the present invention is typically made by mixing the components of the composition together.

In one embodiment, the composition of the present invention is useful as a pumpable liquid source of polysaccharide with a high polysaccharide content for formulating aqueous end use compositions, in particular agricultural pesticide compositions.

In one embodiment, the composition of the present invention is an agricultural adjuvant composition that stable, has a low viscosity, is easily transportable, is pourable and pumpable under field conditions, and is dilutable with water under agricultural field conditions.

In one embodiment, the composition of the present invention is mixed with a pesticide active ingredient and, optionally other adjuvant ingredients, and water to form a dilute pesticide composition for spray application to target pests.

In one embodiment, the composition of the present invention is prepared on an as needed basis and is sufficiently stable, that is, a quiescent sample of the composition shows no evidence, by visual inspection, of gravity driven separation, such as, separation into layers and/or precipitation of components, such as, for example, incompletely hydrated water-soluble polymer, from the liquid medium, within the anticipated time period, for example, one hour, more typically two hours, between preparation and use.

In one embodiment, the composition of the present invention exhibits good storage stability and a quiescent sample of the composition shows no evidence, by visual inspection, of gravity driven separation within a given time, such as, for example, one week, more typically, one month, even more typically 3 months, under given storage conditions, such as, for example, at room temperature.

In one embodiment, the composition of the present invention exhibits good storage stability and a quiescent sample of the composition shows no evidence, by visual inspection, of gravity driven separation within a given time, such as, for example, 24 hours, more typically, four days, even more typically, one week, under accelerated aging conditions at an elevated storage temperature of up to, for example, 54° C., more typically, 45° C.

What is claimed is:

1. A method comprising spray applying an agricultural pesticide composition through an induction flat spray tip nozzle, wherein the agricultural pesticide composition comprises:
a liquid medium;
at least one pesticide;
a guar or a guar derivative, wherein at least a portion of the guar or guar derivative is in the form of particles and at least a portion of the particles are dispersed in the liquid medium;
a glycol, a glycol derivative or a combination thereof; and
a suspending agent,
wherein the induction flat spray tip nozzle comprises a spray tip nozzle body which comprises:
a first end adapted to connect to a liquid supply;
a venturi compartment; and
a discharge orifice,
wherein the agricultural pesticide composition is free or substantially free of ammonium-containing compounds.

2. The method of claim 1 wherein the at least one pesticide is a combination of (i) dicamba or salt thereof and (ii) glyphosate or a salt thereof.

3. The method of claim 1 wherein the at least one pesticide is a combination of (i) 2,4-D or salt thereof and (ii) glyphosate or a salt thereof.

4. The method of claim 1 wherein the glycol derivative is polyethylene glycol.

5. The method of claim 1 further comprising choline chloride, dibasic potassium phosphate, or a combination thereof.

6. The method of claim 1 wherein the guar or a guar derivative is a hydroxypropyl guar or a natural guar.

7. The method of claim 1 wherein the suspending agent is selected from xanthan, fumed silica, or mixtures thereof.

8. The method of claim 1 wherein the liquid medium is an aqueous liquid medium that comprises water or water and a water immiscible organic liquid, and wherein the composition is in the form of an emulsion, a microemulsion, or a suspoemulsion.

9. The method of claim 1 wherein the venturi compartment comprises a longitudinally extending throughhole with an inlet opening in fluid communication with an outlet opening and a venturi section interposed and in fluid communication with said inlet opening and said outlet opening.

10. The method of claim 1 wherein the venturi compartment comprises a first fluid compartment having a first longitudinal axis, a second fluid compartment having a second longitudinal axis, and a venturi section interposed between and in fluid communication with the first fluid compartment and the second fluid compartment.

11. The method of claim 10 wherein venturi section has a diameter that is less than the diameter of the first compartment and less than the diameter of the second compartment.

12. The method of claim 1 wherein the guar derivative comprises cationic guar, carboxymethyl guar (CM guar), hydroxyethyl guar (HE guar), hydroxypropyl guar (HP guar), carboxymethylhydroxypropyl guar (CMHP guar), hydrophobically modified guar (HM guar), hydrophobically modified carboxymethyl guar (HMCM guar), hydrophobically modified hydroxyethyl guar (HMHE guar), hydrophobically modified hydroxypropyl guar (HMHP guar), cationic hydrophobically modified hydroxypropyl guar (cationic HMHP guar), hydrophobically modified carboxymethylhydroxypropyl guar (HMCMHP guar), hydrophobically modified cationic guar (HM cationic guar), guar hydroxypropyl trimonium chloride, hydroxypropyl guar hydroxypropyl trimonium chloride.

13. A method of applying an agricultural pesticide composition the steps of:
contacting at least one pesticide with an adjuvant composition,
wherein the adjuvant composition comprises:
greater than 1.8 wt %, based upon total weight of the adjuvant composition, of an incompletely hydrated water-soluble polymer suspended in a liquid medium;
a hydration inhibitor component comprising a glycol, a glycol derivative, choline chloride, dibasic potassium phosphate or a combination thereof; and
a suspending agent in an amount effective to impart shear thinning properties to the composition;
spray applying a resulting mixture of the at least one pesticide and the adjuvant composition to one or more crops through an induction flat spray tip nozzle,
wherein the induction flat spray tip nozzle comprises a spray tip nozzle body which comprises:
a first end adapted to connect to a liquid supply;
a venturi compartment; and
a discharge orifice,
wherein the agricultural pesticide composition is free or substantially free of ammonium-containing compounds.

14. The method of claim 13 wherein the at least one pesticide is a combination of (i) dicamba or salt thereof and (ii) glyphosate or a salt thereof.

15. The method of claim 13 wherein the at least one pesticide is a combination of (i) 2,4-D or salt thereof and (ii) glyphosate or a salt thereof.

16. The method of claim 13 wherein the hydration inhibitor component comprises polyethylene glycol, choline chloride or a combination thereof.

17. The method of claim 13 wherein the incompletely hydrated water- soluble polymer is a guar or a guar derivative

18. The method of claim 13 wherein the suspending agent is selected from xanthan, fumed silica, or mixtures thereof.

19. The method of claim 13 wherein the venturi compartment comprises a longitudinally extending throughhole with an inlet opening in fluid communication with an outlet opening and a venturi section interposed and in fluid communication with said inlet opening and said outlet opening.

20. The method of claim 13 wherein the venturi compartment comprises a first fluid compartment having a first longitudinal axis, a second fluid compartment having a second longitudinal axis, and a venturi section interposed between and in fluid communication with the first fluid compartment and the second fluid compartment.

21. The method of claim 20 wherein venturi section has a diameter that is less than the diameter of the first compartment and less than the diameter of the second compartment.
